(19) United States
(12) Patent Application Publication
(10) Pub. No.: US 2019/0166079 A1
(43) Pub. Date: May 30, 2019

(54) CONTEXTUAL CONVERSATIONS ON ONLINE SOCIAL NETWORKING SYSTEMS

(71) Applicant: Microsoft Technology licensing, LLC, Redmond, WA (US)

(72) Inventors: Adam Christopher Hobson, Sunnyvale, CA (US); Charles Lai, Milpitas, CA (US); Joshua Levine, Los Altos, CA (US); Naman Goel, San Jose, CA (US); Christina Lynn Lopus, San Francisco, CA (US); Preethi Nagashri, San Jose, CA (US); Guanchao Wang, Dublin, CA (US); Abel Ernesto Sanchez Ali, San Jose, CA (US); Lewis Brandon Douglas Miller, Sunnyvale, CA (US); Rajagopalan Ranganathan, Santa Clara, CA (US)

(21) Appl. No.: 15/825,812

(22) Filed: Nov. 29, 2017

(51) Int. Cl. H04L 12/58; G06F 3/0481

(52) U.S. Cl. CPC H04L 51/24; H04L 67/306; G06F 3/0481; H04L 51/32

(57) ABSTRACT

An online social networking system displays notifications to members. The notifications relate to other members of the online social networking system. The system receives input from members relating to the notifications, and generates a virality of contextual conversations on the online social networking system based on the notifications and the input relating to the notifications.

### TECHNICAL FIELD

The present disclosure generally relates to the technical field of online social networking systems, and in an embodiment, but not by way of limitation, to generating contextual conversations on online social networking systems, and in particular, contextual conversations based on notifications and input relating to the notifications.

### BACKGROUND

Online social networks provide members with the ability to connect and communicate with other members. Online social networks include a personal profile for each member, which includes the educational history, work history, and personal interests of the member. Many online social networks also include a job posting functionality, wherein employers can post available jobs and potential employees can search through the posted job openings. Many online social networks further include a notification feature, wherein a member of the online social network receives notifications relating to such things as other persons viewing the member's profile, job anniversaries of other members, job changes of other members, and birthdays of other members.

### DESCRIPTION OF THE DRAWINGS

Some embodiments are illustrated by way of example and not limitation in the accompanying drawings, in which:

FIG. 1 is a block diagram of the functional modules or components that comprise a computer network-based online social networking system, including application server modules consistent with some embodiments of the invention;

FIG. 2 is a block diagram depicting some example application server modules of FIG. 1;

FIG. 3 is a flow diagram of an example embodiment of creating contextual conversations on an online social networking system based on notifications and input relating to those notifications;

FIG. 4 is an example screenshot of a notification on an online social networking system;

FIG. 5 is an example screenshot of another notification on an online social networking system;

FIG. 6 is an example screenshot of another notification on an online social networking system;

FIG. 7 is an example screenshot of yet another notification on an online social networking system;

FIG. 8 is an example screenshot of a further notification on an online social networking system; and

FIG. 9 is a block diagram of a machine in the form of a computing device within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of the various aspects of different embodiments of the present invention. It will be evident, however, to one skilled in the art that the present invention may be practiced without all of the specific details and/or with variations, permutations, and combinations of the various features and elements described herein.

In an embodiment, an online social networking system displays a first notification to a user of the online social networking system. The first notification relates to one or more members of the online social networking system. The user then submits input relating to the first notification. In response to the user input, the online social network generates a virality of contextual conversations on the online social networking system. The online social networking system further can display a second notification to the user based on the input provided by the user relating to the first notification. The second notification relates to other members of the online social networking system (and may include one or more of the members displayed in the first notification). The user then submits input relating to the second notification. After receiving the second input, the online social networking system can generate a further virality of contextual conversations on the online social networking system. The virality of contextual conversations means that the conversations generated among the user and the members based on the notifications and input relating to the notifications spread like a virus. The virality of contextual conversations is rooted in one or more of the first notification, the second notification, the input from the user based on the first notification, and the input from the user based on the second notification. The virality of contextual conversations is further propagated by displaying a plurality of notifications to a plurality of members based on input received from the plurality of members relating to the plurality of notifications. The feature of generating the virality of contextual conversations is accomplished via several user interfaces, which solves the technical problem of prior notification systems that permitted only one user interface and consequently no virality of contextual conversations.

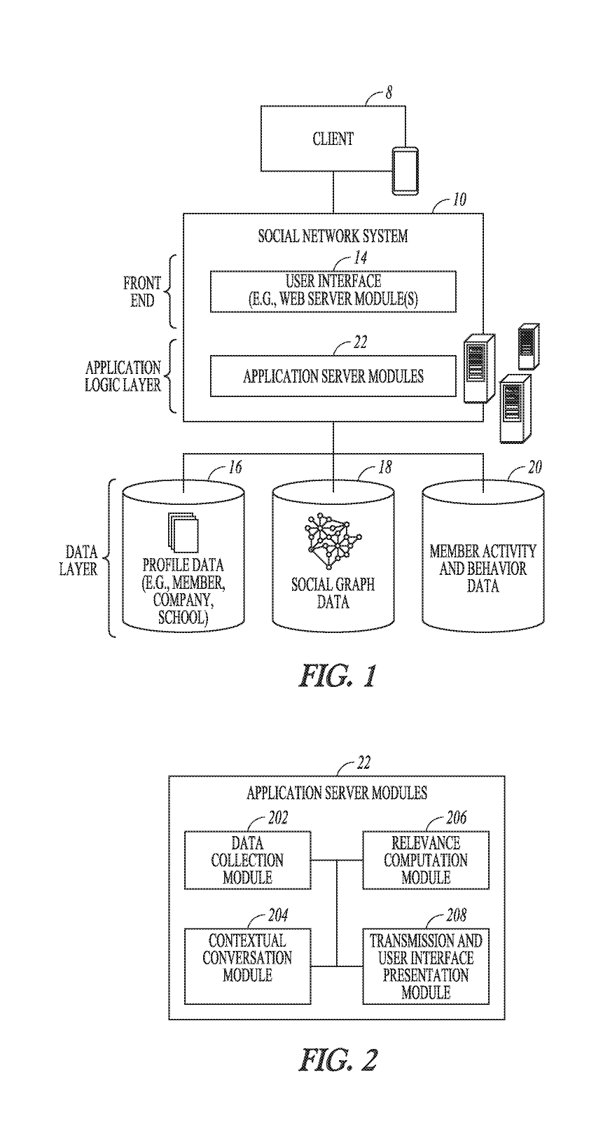

Referring now to the drawings, FIG. 1 is a block diagram of the functional modules or components that comprise a computer-based or network-based online social networking system 10 consistent with some embodiments of the invention. As shown in FIG. 1, the online social networking system 10 is generally based on a three-tiered architecture, comprising a front-end layer, application logic layer, and data layer, and can communicate with a client device 8. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the present subject matter with unnecessary details, various functional modules and engines that are not germane to conveying an understanding of the present subject matter have been omitted from FIG. 1. However, a skilled artisan will readily recognize that various additional functional modules and engines may be used with an online social networking service, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the present subject matter is by no means limited to such architecture.

As shown in FIG. 1, the front end comprises a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. The client devices may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the online social networking service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the online social networking service. A “connection” may require a bi-lateral agreement by the members, such that both members acknowledge the establishment of the connection. The degree of connectivity refers to the amount or number of connections that exist for a particular person and/or the amount or number of connections among a group of persons. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the online social networking service may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generate various user interfaces (e.g., web pages) with data retrieved from various data sources in the data layer. With some embodiments, individual application server modules 22 are used to implement the functionality associated with various applications, services and features of the online social networking service. For instance, a messaging application, such as an email application, an instant messaging application, or some hybrid or variation of the two, may be implemented with one or more application server modules 22. Of course, other applications or services may be separately embodied in their own application server modules 22.

The online social networking service may provide a broad range of applications and services that allow members the opportunity to share and receive information, often customized to the interests of the member. For example, with some embodiments, the online social networking service may include a photo sharing application that allows members to upload and share photos with other members. As such, at least with some embodiments, a photograph may be a property or entity included within a social graph. With some embodiments, members of an online social networking service may be able to self-organize into groups, or interest groups, organized around a subject matter or topic of interest. Accordingly, the data for a group may be stored in a database. When a member joins a group, his or her membership in the group will be reflected in the social graph data stored in the database with reference number 18. With some embodiments, members may subscribe to or join groups affiliated with one or more companies. For instance, with some embodiments, members of the online social networking service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modeled with the social graph data of the database with reference number 18.

FIG. 2 is a block diagram of several example modules that can make up the application server modules 22 of FIG. 1. A data collection module 202 can execute functions such as receiving user input in response to notifications. A contextual conversation module 204 can execute functions such as using the input received from a user in response to a notification, and generating further notifications to members based on that user input. A relevance computation module 206 can execute functions such as computing the relevance of certain user actions and connections on the online social networking system. A transmission and user interface module 208 can execute functions such as displaying notification pages to users.

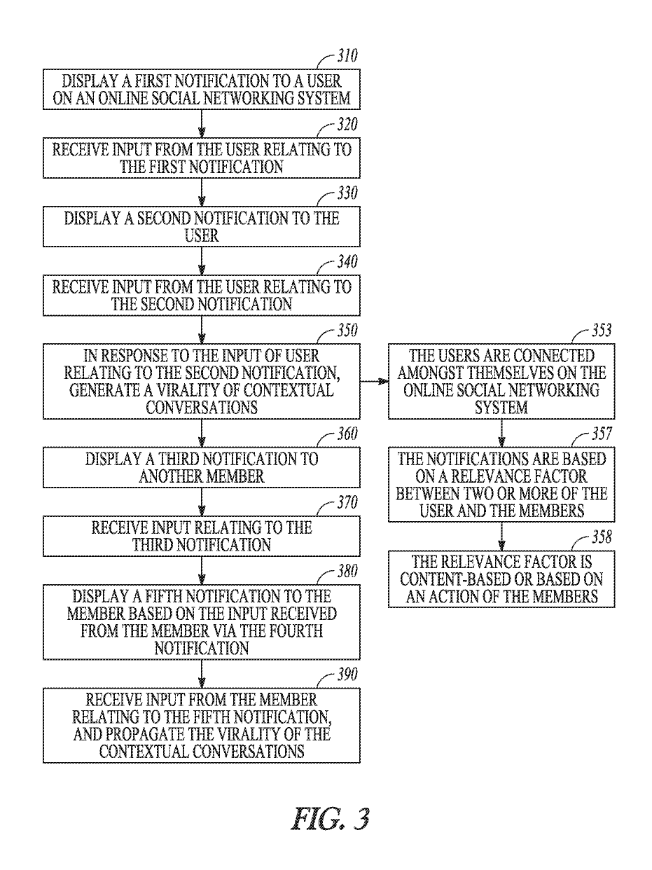

FIG. 3 is a flow diagram illustrating an example method of creating a viral propagation of notifications in an online social networking system, thereby creating a plurality of contextual conversations. In various embodiments, the method may be implemented by one or more of the modules or processors of FIG. 1 and/or FIG. 2. FIG. 3 includes a number of process blocks 310-390. Though arranged substantially serially in the example of FIG. 3, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

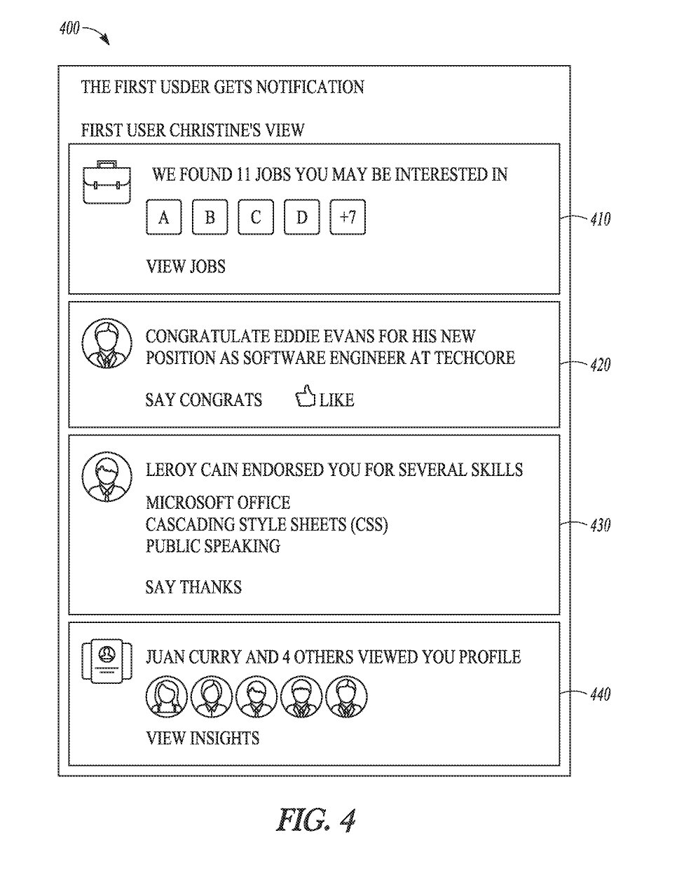

Referring now specifically to FIG. 3, at 310, the online social networking system displays a first notification to a user. The first notification relates to one or more members of the online social networking system. For example, as illustrated in FIG. 4, a notification 400 can include notifications relating to jobs that a user Christine may be interested in (410), an opportunity for the user Christine to congratulate another member on a new job (420), a notification that another member endorsed the user Christine for several skills (430), and a notification that other members have viewed the user Christine's online profile (440). A notification 400 can also relate to a work anniversary of a member, a birthday of a member, a sharing of content by a member, and a message to a user that a member liked, commented on, or approved of the notification relating to the user. The notifications can take the form of an email, a text message, or a feed on the online social networking system.

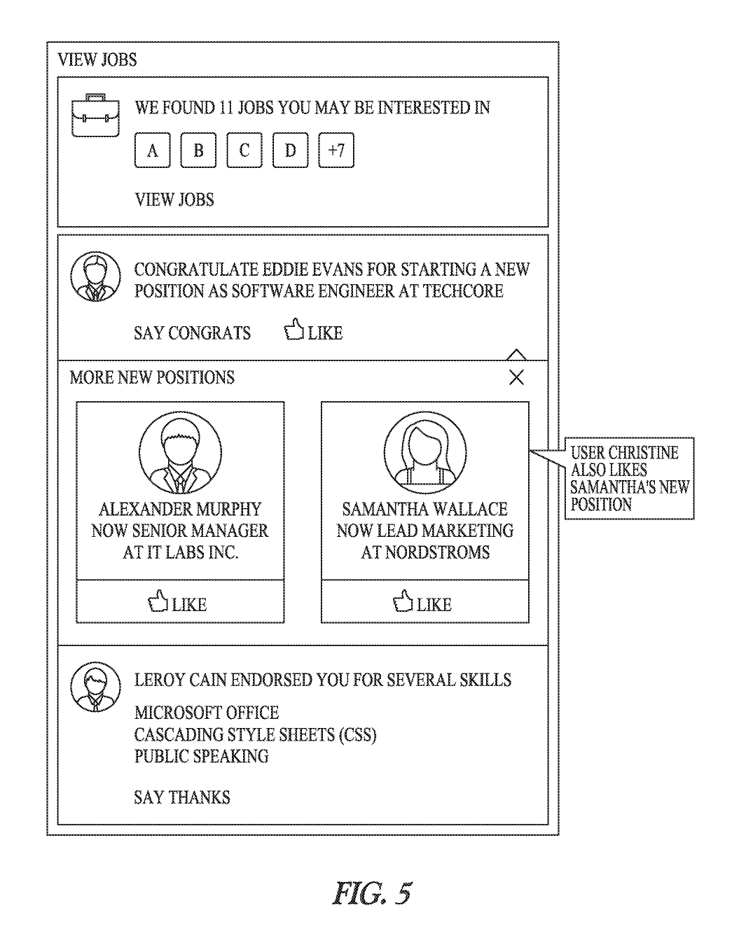

At 320, the user Christine submits to the online social networking system input relating to the first notification. This input can be Christine congratulating another member on an accomplishment or anniversary, and can lead to comments and also trigger virality. For example, in response to first notification 420, the user Christine may congratulate the member Eddie Evans identified in the first notification 420 who just started a new job position. In response to receiving the input of the user Christine, at 330, the online social networking system displays a second notification to the user Christine. The second notification is based on the input received from the user Christine relating to the first notification (that is, Christine's congratulatory message relating to the member's (Eddie Evans) new job position). The second notification can relate to one or more other members (that is, members other than those appearing in the first notification) of the online social networking system. In an embodiment, one or more members from the first notification can also appear in the second notification. An example of the second notification is illustrated in FIG. 5, wherein the online social networking system displays to the user Christine several more members who have just started at a new job.

At 340, the user Christine submits to the online social networking system input relating to the second notification. For example, as noted in FIG. 5, the user Christine can further indicate that she likes member Samantha's new job position. At 350, the online social networking system, in response to the input of user Christine relating to the second notification, generates a virality of contextual conversations on the online social networking system. The virality of contextual conversations is rooted in one or more of the first notification, the second notification, the input from the user Christine based on the first notification, and the input from the user Christine based on the second notification. Moreover, the virality of contextual conversations is propagated by displaying a plurality of notifications to a plurality of members based on input received from the plurality of members relating to the plurality of notifications. As noted at 353, in an embodiment, the plurality of users is connected amongst themselves on the online social networking system. Additionally, at 357, the notifications are based on a relevance factor between two or more of the user Christine and the members, and as indicated at 358, the relevance factor is content-based, action-based, or actor-based. A content-based relevance factor relates to the function of showing more content that is similar to the content in the notification. For example, if a user Tom likes Christina's article on tax reform, the system would suggest to Tom other content from other members on politics and/or government policies. An action-based relevance factor relates to events such as birthdays or work anniversaries. For example, if user Tom likes Christina's birthday, then Tom can be shown more birthdays among Tom's connections. An actor-based relevance factor relates to more recent activity about the same member (actor) with which the member just interacted. For example, if user Tom likes Christina's work anniversary, then more recent activities of Christina is shown to Tom.

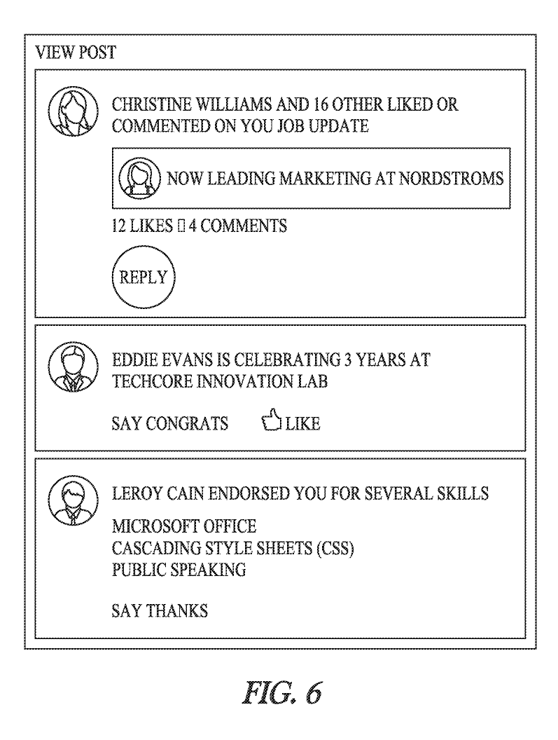

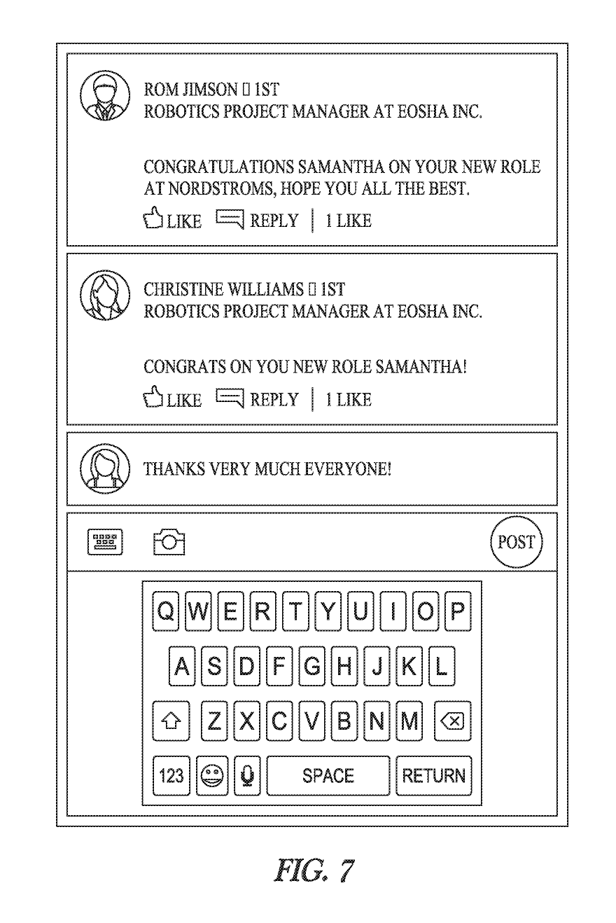

More specifically, FIGS. 6, 7, and 8 illustrate an example of this virality. At 360, the online social networking system displays a third notification to one of the other members (that is, members appearing in the second notification) based on the input received from the user Christine relating to the second notification. An example of such a third notification is illustrated in FIG. 6. In FIG. 6, a third notification is displayed to member Samantha (one of the other members in FIG. 5) informing member Samantha that user Christine congratulated Samantha on Samantha's new job position. Thereafter, at 370, member Samantha submits to the online social networking system input relating to the third notification. The input from member Samantha can be received into the online social networking system via a content update page (the content update page can also be referred to as a fourth notification). FIG. 7 illustrates an example of such a content update page, wherein member Samantha enters a message thanking the members who congratulated her on her new job position.

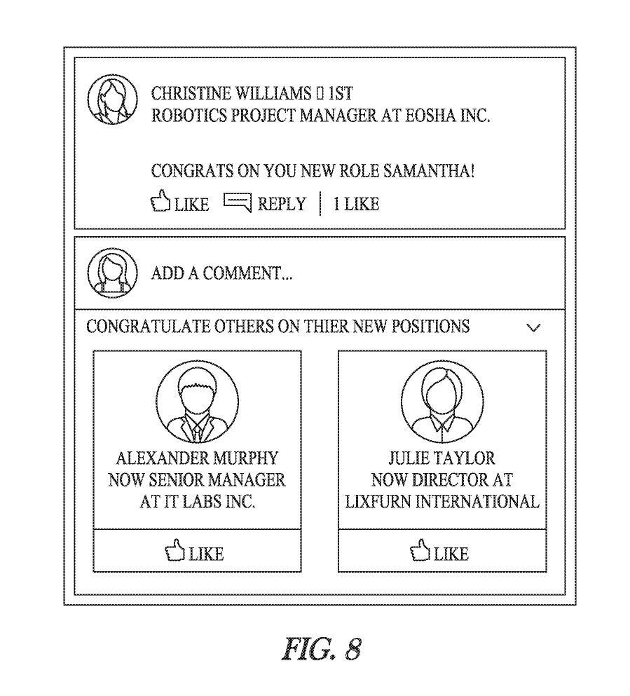

At 380, the online social networking system displays a fifth notification to the member Samantha based on the input received from Samantha via the content update page (or fourth notification). The fifth notification relates to one or more other members of the online social networking system. The one or more other members can be members from any of the previous notifications, and/or the one or more other members can be members who have not appeared in any of the previous notifications. FIG. 8 illustrates an example of a fifth notification. As can be seen from the example in FIG. 8, a member is displayed (Alexander) who appeared in a previous notification (FIG. 5, second notification), and a member (Julie) who has not appeared in a previous notification. At 390, member Samantha submits to the online social networking system input relating to the fifth notification, which propagates the virality of the contextual conversations.

As one can see, the online social networking system can continue to propagate these notifications through many iterations, thereby generating the contextual conversations. Specifically, the online social networking system further generates the virality of contextual conversations via a propagation using the third notification (FIG. 6) to the member Samantha based on the input received from the user Christina relating to the second notification (FIG. 5), the input from the member Samantha relating to the third notification (FIG. 6), the fourth notification (FIG. 7, content update page) based on the input from the member Samantha in response to the third notification (FIG. 6), the fifth notification (FIG. 8) to the member Samantha based on the input received from Samantha (FIG. 7) in response to the third notification (FIG. 6), and any input from member Samantha relating to the fifth notification. As noted, the online social networking system can generate and regenerate these notifications multiple times, thereby generating the virality of contextual conversations for the user, the first member, the second member, and the third member.

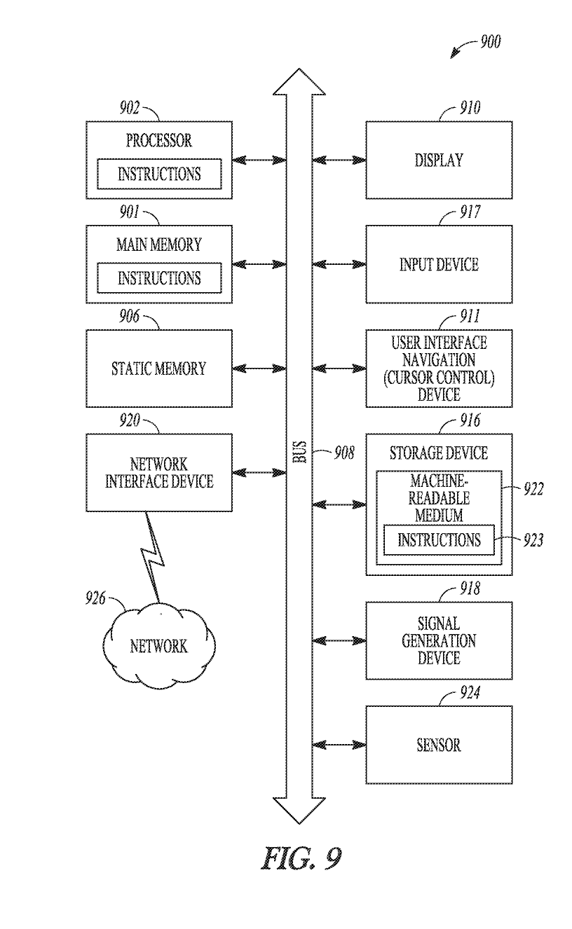

FIG. 9 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 901 and a static memory 906, which communicate with each other via a bus 908. The computer system 900 may further include a display unit 910, an alphanumeric input device 917 (e.g., a keyboard), and a user interface (UI) navigation device 911 (e.g., a mouse). In one embodiment, the display, input device and cursor control device are a touch screen display. The computer system 900 may additionally include a storage device 916 (e.g., drive unit), a signal generation device 918 (e.g., a speaker), a network interface device 920, and one or more sensors 921, such as a global positioning system sensor, compass, accelerometer, or other sensor.

The drive unit 916 includes a machine-readable medium 922 on which is stored one or more sets of instructions and data structures (e.g., software 923) embodying or utilized by any one or more of the methodologies or functions described herein. The software 923 may also reside, completely or at least partially, within the main memory 901 and/or within the processor 902 during execution thereof by the computer system 900, the main memory 901 and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 923 may further be transmitted or received over a communications network 926 using a transmission medium via the network interface device 920 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A memory device, the memory device communicatively coupled to a processor and comprising instructions which, when performed using the processor, cause the processor to:
(a) display a first notification to a user on an online social networking system, the first notification relating to a first member of the online social networking system;
(b) receive input from the user relating to the first notification; and
(c) generate a virality of contextual conversations on the online social networking system; wherein the virality of contextual conversations is rooted in the first notification and the input from the user based on the first notification.

2. The memory device of claim 1, comprising instructions that cause the processor to:
(d) display a second notification to the user based on the input received from the user relating to the first notification, the second notification relating to a second member of the online social networking system;
(e) receive input from the user relating to the second notification; and
(f) generate the virality of contextual conversations on the online social networking system; wherein the virality of contextual conversations is rooted in the first notification, the second notification, the input from the user based on the first notification, and the input from the user based on the second notification

3. The memory device of claim 2, comprising instructions that cause the processor to further propagate the virality of contextual conversations by displaying a plurality of notifications to a plurality of members based on input received from the plurality of members relating to the plurality of notifications; wherein the plurality of notifications and the plurality of members are rooted in the first notification relating to the first member.

4. The memory device of claim 3, wherein the virality of contextual conversations is generated by the memory device instructions which, when performed using the processor, cause the processor to:
(g) display a third notification to the second member based on the input received from the user relating to the second notification;
(h) receive input from the second member relating to the third notification;
(i) display a fourth notification comprising a content update page to the second member based on the input from the second member relating to the third notification;
(j) display a fifth notification to the second member based on the input received from the second member relating to one or more of the third notification and the fourth notification, the fifth notification relating to a third member of the online social networking system; and
(k) receive input from the second member relating to the fifth notification.

5. The memory device of claim 4, comprising memory device instructions which, when performed using the processor, cause the processor to further generate the virality of contextual conversations; wherein the further generation of the virality of contextual conversations is propagated using the third notification to the second member based on the input received from the user relating to the second notification, the input from the second member relating to the third notification, the fourth notification to the second member based on the input from the second member relating to the third notification, the fifth notification to the second member based on the input received from the second member relating to the one or more of the third notification and the fourth notification, and the input from the second member relating to the fifth notification.

6. The memory device of claim 4, wherein operations (a), (b), (c), (d), (e), (f), (g), (h), (i), (j), and (k) are executed two or more times, thereby generating the virality of contextual conversations for the user, the first member, the second member, and the third member.

7. The memory device of claim 2, wherein the first notification and the second notification comprise one or more of a work anniversary of the first member or the second member, a job change of the first member or the second member, a birthday of the first member or the second member, and a sharing of content by the first member or the second member.

8. The memory device of claim 4, wherein the third notification comprises a message to the second member that the user liked, commented on, or approved of the notification relating to the second member.

9. The memory device of claim 1, wherein the input from the user comprises transmitting a congratulatory message to the first member or the second member, or indicating that the user likes or approves of the first notification or the second notification.

10. The memory device of claim 1, wherein the first notification and the second notification comprise an email or a text message.

11. The memory device of claim 4, wherein two or more of the user, the first member, the second member, and the third member are connected on the online social networking system.

12. The memory device of claim 4, wherein the first notification, the second notification, the third notification, the fourth notification, and the fifth notification are based on a relevance factor between two or more of the user and the first member, the second member, and the third member.

13. The memory device of claim 12, wherein the relevance factor is content-based or based on an action of the first member, the second member, the third member, or the fourth member.

14. A system comprising a computer processor operable to:
(a) display a first notification to a user on an online social networking system, the first notification relating to a first member of the online social networking system;
(b) receive input from the user relating to the first notification; and
(c) generate a virality of contextual conversations on the online social networking system; wherein the virality of contextual conversations is rooted in the first notification and the input from the user based on the first notification.

15. The system of claim 14, wherein the computer processor is operable to:
(d) display a second notification to the user based on the input received from the user relating to the first notification, the second notification relating to a second member of the online social networking system;
(e) receive input from the user relating to the second notification; and
(f) generate the virality of contextual conversations on the online social networking system; wherein the virality of contextual conversations is rooted in the first notification, the second notification, the input from the user based on the first notification, and the input from the user based on the second notification.

16. The system of claim 15, wherein the processor is operable to further propagate the virality of contextual conversations by displaying a plurality of notifications to a plurality of members based on input received from the plurality of members relating to the plurality of notifications; wherein the plurality of notifications and the plurality of members are rooted in the first notification relating to the first member.

17. The system of claim 15, wherein the computer processor is further operable to:
(g) display a third notification to the second member based on the input received from the user relating to the second notification;
(h) receive input from the second member relating to the third notification;
(i) display a fourth notification comprising a content update page to the second member based on the input from the second member relating to the third notification;
(j) display a fifth notification to the second member based on the input received from the second member relating to one or more of the third notification and the fourth notification, the fifth notification relating to a third member of the online social networking system; and
(k) receive input from the second member relating to the fifth notification.

18. A process comprising:
(a) displaying a first notification to a user on an online social networking system, the first notification relating to a first member of the online social networking system;
(b) receiving input from the user relating to the first notification; and
(c) generating a virality of contextual conversations on the online social networking system; wherein the virality of contextual conversations is rooted in the first notification and the input from the user based on the first notification.

19. The process of claim 18, comprising:
(d) displaying a second notification to the user based on the input received from the user relating to the first notification, the second notification relating to a second member of the online social networking system;
(e) receiving input from the user relating to the second notification; and
(f) generating the virality of contextual conversations on the online social networking system; wherein the virality of contextual conversations is rooted in the first notification, the second notification, the input from the user based on the first notification, and the input from the user based on the second notification.

20. The process of claim 19, comprising further propagating the virality of contextual conversations by displaying a plurality of notifications to a plurality of members based on input received from the plurality of members relating to the plurality of notifications; wherein the plurality of notifications and the plurality of members are rooted in the first notification relating to the first member; and
(g) displaying a third notification to the second member based on the input received from the user relating to the second notification;
(h) receiving input from the second member relating to the third notification;
(i) displaying a fourth notification comprising a content update page to the second member based on the input from the second member relating to the third notification;
(j) displaying a fifth notification to the second member based on the input received from the second member relating to one or more of the third notification and the fourth notification, the fifth notification relating to a third member of the online social networking system; and
(k) receiving input from the second member relating to the fifth notification.
